(19) United States
(12) Patent Application Publication
(10) Pub. No.: US 2026/0186519 A1
(43) Pub. Date: Jul. 2, 2026

(54) ELECTRIC POWER CONTROL METHOD AND VOLTAGE CONVERTER THEREFOR IN MAXIMUM POWER POINT TRACKING CONTROL

(71) Applicants: CEF CO., LTD., Nemuro-shi, Hokkaido (JP); MERSINTEL, K.K., Kyoto-shi, Kyoto (JP)

(72) Inventors: Hiroyuki NISHIMURA, Kyoto-shi, Kyoto (JP); Ichiro KUBO, Kyoto-shi, Kyoto (JP); Takeshi TOMINAGA, Kyoto-shi, Kyoto (JP)

(21) Appl. No.: 18/840,908

(22) PCT Filed: Aug. 4, 2023
(86) PCT No.: PCT/JP2023/028513

§ 371 Date: Aug. 23, 2024

(30) Foreign Application Priority Data
Aug. 9, 2022 (JP) 2022-127146

(51) Int. Cl. G05F 1/67; H02J 3/38; H02J 101/24

(52) U.S. Cl. CPC G05F 1/67; H02J 3/381; H02J 2101/25

(57) ABSTRACT

To provide an electric power control method and a voltage converter therefor in maximum power point tracking control (MPPT) related to an optimizer connectable to most commercially available PCSs. With reference to a voltage value of a maximum power point MPPT provided as an apex of a voltage-power curve, an optimum operating point, at which power of solar panels is maximized, is kept at a constant power value by inducing an operating voltage of the power conditioner so as to fall within a flat sub-region of a plateau shape, which has a step formed by straight lines falling down vertically on both low-voltage side and high-voltage side of the voltage-power curve and abutting the slopes of the voltage-power curve, subsequently the operating voltage of the power conditioner is kept in a constant fixed range and outputted to the outside.

### TECHNICAL FIELD

The present invention relates to an electric power control method and a voltage converter therefor in maximum power point tracking control used to obtain generated output of a solar module made up of a plurality of solar panels, at maximum efficiency.

### BACKGROUND ART

As a means of securing energy in order to realize a low-carbon society, photovoltaic generation (also referred to as solar power generation) has been put to practical use. Solar power generation is designed to obtain predetermined electric power using one or more solar panels (photo-voltaic panels (PV panels): hereinafter also referred to simply as solar panels) arranged in a plane.

Solar power generation facilities are widely used for facilities ranging from small-scale household facilities to large-scale facilities in lieu of existing power generation facilities such as thermal or nuclear power generation facilities. In particular, the large-scale facilities included in the concept of power plants (power stations) are also called Mega Solar (mega solar power plants).

Using thousands to tens of thousands or more panels placed as module groups on the ground, on the water, or the like, Mega Solar converts electromagnetic wave energy of sunlight into electric power energy and transmits the electric power energy to customers. To extract power output from the large number of panels, connections among the panels in the module can use either a series scheme or a parallel scheme.

FIG. 7 is an explanatory diagram of a parallel panel connection scheme in a solar module adopted by the present invention. In FIG. 7, a large number of panels 3 are arrayed as a single solar module (hereinafter also referred to simply as a module) 60 in a power generation site. One module outputs a required voltage by interconnecting power outputs from a large number of panels 3 such as 10 panels or 20 panels via intra-module parallel connection wires 21. Note that such a solar module may sometimes be referred to as a string. Whereas only a single solar module 60 is shown in FIG. 7, non-illustrated other solar modules are connected to a power conditioning system (PCS; also referred to as a power conditioner) 7 via non-illustrated inter-module parallel connection wires.

In the parallel panel connection scheme shown in FIG. 7, each panel 3 includes an optimizer 4 containing an optimizer (OP) circuit provided with a boost function. The optimizer 4 has a function of interconnecting with other panels and non-illustrated other modules. If a voltage at a maximum power point of a single panel is, for example, 40 V (DC), the optimizer circuit boosts the voltage, for example, to 800 V (the target voltage is set to a desired value by the power conditioner) by a boosting circuit. In the parallel connection scheme, the 800-V output of the optimizer 4 of each panel is connected to the intra-module parallel connection wire 21. Therefore, the voltage of the solar module 60 is 800 V. The output is adjusted to a required AC voltage or the like by a power conditioner 7 and supplied to loads of customers via a system line 8.

With this type of solar power generation facility that uses sunlight as an energy source, amounts of sunlight falling on panel surfaces vary greatly depending on the season and time, the location of the power generation site, shadows of standing trees and the like, weather conditions, adhesion of foreign matter, and the like, resulting in variations in the amount of power generation. As a technique for reducing the variations, maximum power point tracking control (MPPT) is adopted. MPPT (maximum power point tracking) involves automatically finding an operating point that maximizes the product of voltage and current that can maximize generated power output of the panels.

There is a large amount of related art that discloses conventional techniques relevant to MPPT control applied to the present invention, but Patent Literature 1 and Patent Literature 2 can be cited as examples.

### CITATION LIST

### Patent Literature

Patent Literature 1: Japanese Translation of PCT International Application Publication No. 2009-540419
Patent Literature 2: Japanese Patent Laid-Open No. 2018-195225

### SUMMARY OF INVENTION

### Technical Problem

As described above, to extract power output from the large number of panels, connections among the panels in the module can use either a series scheme or a parallel scheme. With the series scheme, a failure of a single panel or casting of shadows (variation among amounts of received light) affect the entire module, reducing or losing electric power of the module. This poses a problem in that electric power generated properly by other panels in the module is wasted. Such waste is a problem to be solved from the viewpoint of SDGs as well.

To solve the above problems, the present inventors have developed a scheme in which an optimizer is provided on a panel-by-panel basis, MPPT (maximum power point tracking control) is performed on a panel-by-panel basis, and power is outputted to a power conditioner by connecting the panels subjected to MPPT control in parallel. In this way, by using the parallel connection scheme, in which an optimizer is provided on a panel-by-panel basis and outputs from the panels are connected to the power conditioner in parallel, an impact of reductions in generated output (local reduction in the amount of light irradiating the module) caused by a panel failure or shadows can be limited to panels in the module. However, it is assumed that the power conditioner has a function to set constant-voltage maintenance.

However, many of commercially available power conditioners are of a type that has an MPPT function, but does not have a function to set constant-voltage maintenance. Therefore, some power generation sites that have adopted a commercially available power conditioner cannot adopt an optimizer. This is also a problem to be solved.

FIGS. 4(a) to 4(c) are explanatory diagrams for explaining MPPT, where FIG. 4(a) shows a voltage-power curve (P-V curve) of a panel, FIG. 4(b) shows a power conditioner of a constant-voltage maintenance type (constant-voltage PCS), and FIG. 4(c) shows a power conditioner with only an MPPT function (MPPT PCS).

FIGS. 5(a) and 5(b) are explanatory diagrams of a voltage-power curve classified by optimizer function, where FIG. 5(a) is an explanatory diagram of a voltage-power curve of a full-voltage OP-MPPT type optimizer corresponding to FIG. 4(a), and FIG. 5(b) is an explanatory diagram of a voltage-power curve (P-V curve) of an optimizer having an after-mentioned control function of a plateau shape relevant to the present invention (where the “plateau shape” means a relatively flat, stable plateau-like interval rather than a “trapezoid” in the geometric sense).

Conceivable power conditioners include a power conditioner shown in FIG. 4(b) and provided with the capability of maintaining a constant voltage (such as 800 V) in addition to an original MPPT control function and a power conditioner shown in FIG. 4(c) and provided with only an MPPT function. The PCS (constant-voltage PCS) of the constant-voltage maintenance type shown in FIG. 4(b) is designed to be able to maintain a constant voltage (A) represented by the voltage-power curve (P-V curve) shown in FIG. 4(a).

In actual operation, suitably the constant voltage (A) is set to a value close to an MPPT voltage of the panels making up the module (i.e., for example, 800 V if 20 panels of 40 V each are used).

However, as described above, many of commercially available power conditioners are of a type that has an MPPT function, but does not have a function to set constant-voltage maintenance. Consequently, some sites (such as power plants) that have adopted a commercially available power conditioner cannot adopt an optimizer.

An object of the present invention, which concerns a technique related to an optimizer connectable to most of commercially available power conditioners, is to solve the above problems, and more particularly, to provide a novel electric power control method and a voltage converter therefor in maximum power point tracking control (MPPT).

### Solution to Problem

Description will be given below of configurations of major features of the electric power control method and the voltage converter therefor in maximum power point tracking control according to the present invention made in order to achieve the above object.

To begin with, an electric power control method for maximum power point tracking control intended to efficiently extract generated output of a solar module made up of a large number of solar panels is as follows.

The present invention provides an electric power control method for maximum power point tracking control intended to efficiently extract generated output of a solar module made up of a large number of solar panels, wherein: the solar module includes an optimizer adapted to boost power output of the solar module to a predetermined voltage, and a power conditioner provided with an MPPT function; and
(1) the optimizer inductively controls an operating voltage of the power conditioner so as to adjust an MPPT target voltage of the power conditioner based on a voltage-power characteristic curve of the optimizer.
(2) The optimizer inductively controls the operating voltage of the power conditioner as described in 1. and 2. below.
1. When the voltage of the power conditioner is lower than a target value (on the left side of FIG. 1), if the power conditioner increases its voltage, the optimizer increases output power and if the power conditioner decreases its operating voltage, the optimizer decreases the output power.
2. When the voltage of the power conditioner is higher than the target value (on the right side of FIG. 1), if the power conditioner increases its voltage, the optimizer decreases the output power and if the power conditioner decreases its voltage, the optimizer increases the output power.

The present invention provides a voltage converter for maximum power point tracking control intended to efficiently extract generated output of a solar module made up of a large number of solar panels, the voltage converter comprising: an optimizer adapted to boost power output of a solar module to a predetermined voltage, and a power conditioner provided with an MPPT function, wherein
(3) each of the solar panels includes an optimizer and a power conditioner provided with a maximum power point tracking circuit, and the maximum power point tracking circuit includes a controller configured to keep power of the solar panel to a constant power value with reference to a voltage value of a maximum power point provided as an apex of a voltage-power curve at which voltage of the solar panel is at a maximum, such that the voltage-power curve will form a plateau shape having a step formed by straight lines falling down vertically on a low-voltage side and a high-voltage side, respectively, and abutting slopes of the voltage-power curve, and
using the electric power control method described in (1) or (2) above, the controller induces an operating voltage of the power conditioner in a constant fixed range in a flat sub-region of the plateau shape, subsequently keeps the operating voltage of the power conditioner in the constant fixed range, and outputs the operating voltage as generated output.
(4) If a voltage at the maximum power point in the voltage-power curve is D_{T} (V), a voltage that matches the voltage-power curve on the low-voltage side of the plateau shape is D_{L} (V), and a voltage on the high-voltage side of the plateau shape is D_{H} (V); D_{L}<D_{H}, values of power at a point of D_{L} (V) and power at a point of D_{H} are such that circuits making up the optimizer and the power conditioner can recognize power difference more clearly than a value of power at a point of D_{T} (V) in power point tracking control and that the D_{L} and the D_{H} have power values slightly lower than a power value of the plateau shape. Actually, the power difference is a design value established as a circuit ability (accuracy) during circuit design and is about a few percent to ten percent, but may be made larger depending on voltage identification accuracy (ability) of the circuit or MPPT control ability of the power conditioner.

The voltage converter is connected to the power conditioner via a parallel connection wire used to connect generated output of the module in parallel; and outputs the generated output to a system line by converting the generated output into a power form required by a system using the power conditioner.

Note that the present invention is not limited to the configuration described above or a configuration described in an embodiment described later, and needless to say, various changes are possible within the scope of the technical idea of the present invention.

### Advantageous Effects of Invention

Plateau shape control according to the present invention allows optimizers to be connected regardless of functions of commercially available power conditioners and allows maximum power output to be extracted on a panel-by-panel basis.

### BRIEF DESCRIPTION OF DRAWINGS

FIG. 1 is an explanatory diagram of a voltage-power characteristic curve (P-V curve) illustrating an embodiment of an electric power control method and a voltage converter therefor in maximum power point tracking control according to the present invention.

FIG. 2 is a functional block diagram of hardware used to perform OP-MPPT control shown in FIG. 1.

FIG. 3 is a flowchart illustrating a flow of control performed by a controller 45.

FIG. 4 FIGS. 4(a) to 4(c) are explanatory diagrams for explaining MPPT, where FIG. 4(a) shows a voltage-power curve (P-V curve) of a panel, FIG. 4(b) shows a PCS (constant-voltage PCS) of a constant-voltage maintenance type, and FIG. 4(c) shows a PCS with only an MPPT function (MPPT PCS).

FIG. 5 FIGS. 5(a) and 5(b) are explanatory diagrams of a voltage-power curve classified by optimizer function, where FIG. 5(a) is an explanatory diagram of a voltage-power curve of a full-voltage OP-MPPT type optimizer corresponding to FIG. 4(a), and FIG. 5(b) is an explanatory diagram of a voltage-power curve (P-V curve) of an optimizer having an after-mentioned control function of a plateau shape relevant to the present invention.

FIG. 6 FIGS. 6(a) and 6(b) are explanatory diagrams of a P-V curve of optimizer output, where FIG. 6(a) shows triangular control (so-called climbing control) and FIG. 6(b) shows plateau shape control (without a boundary step).

FIG. 7 is an explanatory diagram of a parallel panel connection scheme in a solar module adopted by the present invention.

### DESCRIPTION OF EMBODIMENT

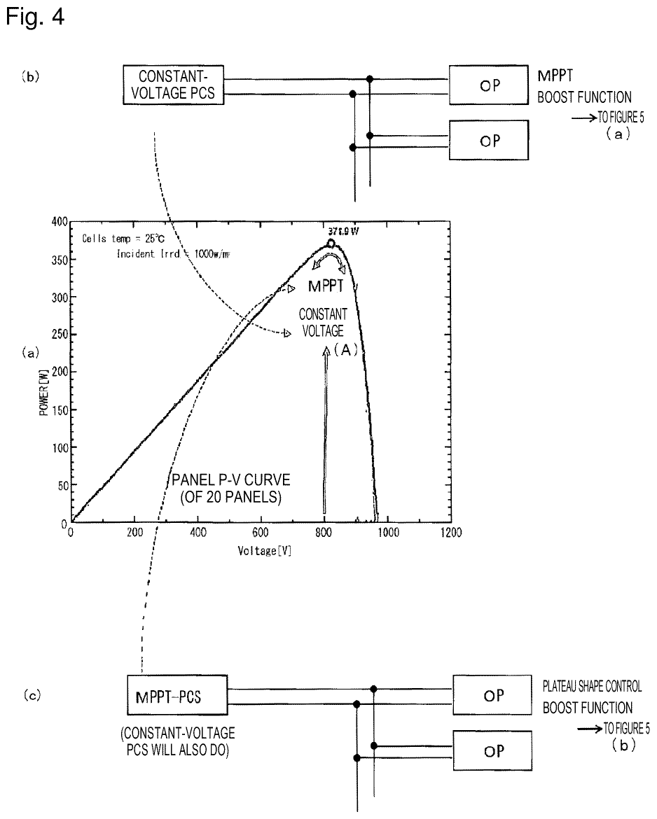

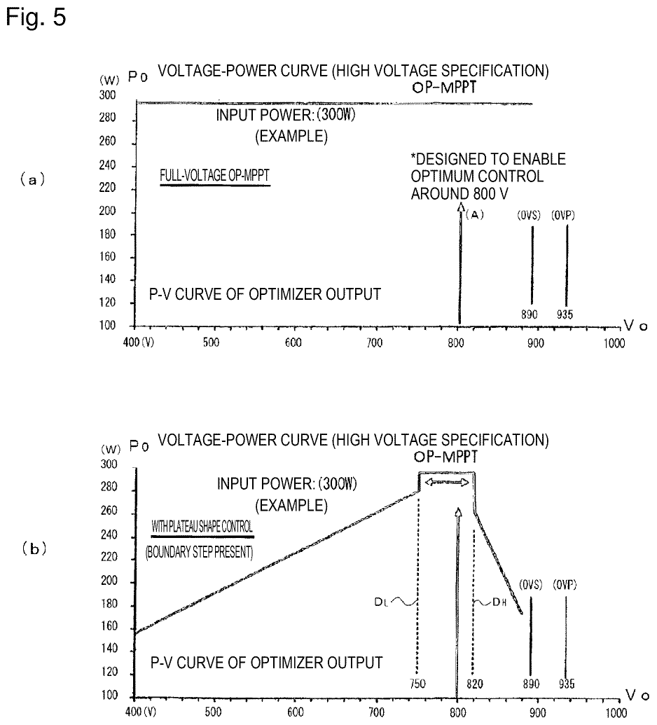

The present invention provides a method and means of connecting an optimizer (OP) to MPPT-PCS shown in FIG. 4(c) and FIG. 5(b). First, regarding MPPT control of the optimizer, an existing control method and a control method according to the present invention will be described.

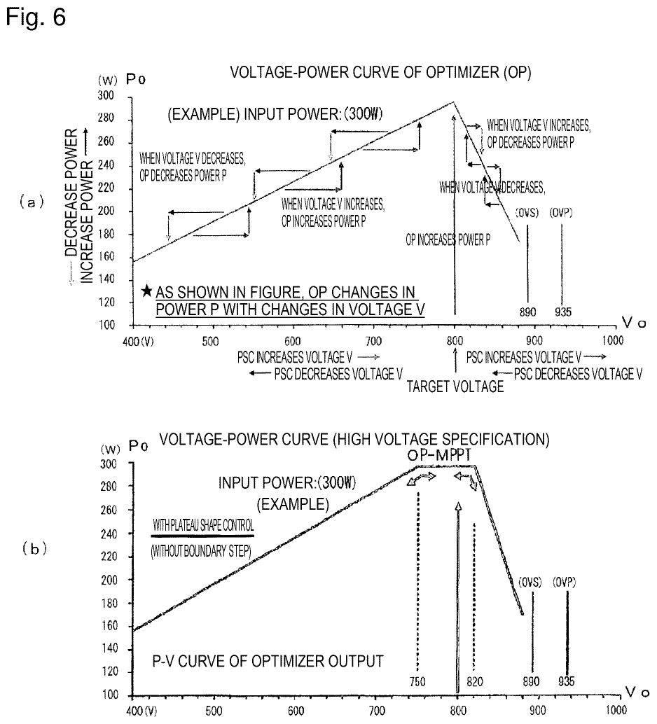

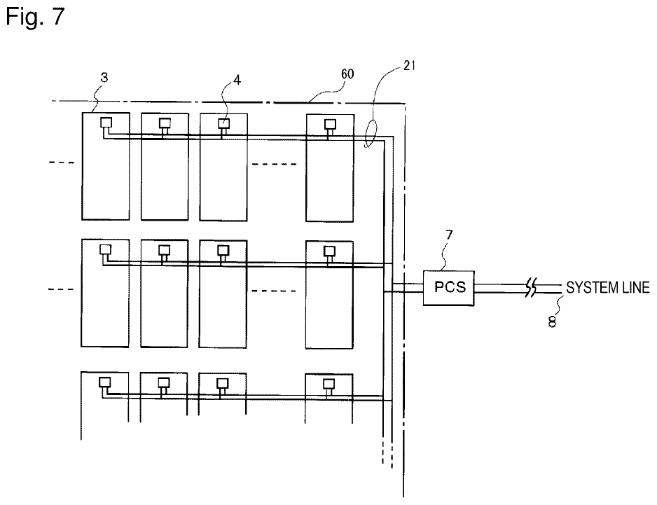

FIGS. 6(a) and 6(b) are explanatory diagrams of a P-V curve of optimizer output, where FIG. 6(a) shows triangular control (so-called climbing control) and FIG. 6(b) shows plateau shape control (without a boundary step). In FIG. 6(a), the optimizer inductively controls an operating voltage of the power conditioner so as to adjust an MPPT target voltage of the power conditioner based on a voltage-power characteristic curve of the optimizer.

That is, when voltage of the power conditioner is lower than a target value, if the power conditioner increases its voltage, the optimizer increases output power and if the power conditioner decreases its voltage, the optimizer decreases the output power.

When the voltage of the power conditioner is higher than the target value, if the power conditioner increases its voltage, the optimizer decreases the output power and if the power conditioner decreases its voltage, the optimizer increases the output power.

As shown in FIG. 4(a), the MPPT-PCS performs MPPT control aiming at an apex of a P-V curve of a panel by changing a voltage in a direction of increasing the voltage. In the case of FIG. 6(a), the voltage is changed aiming at 800 V (800 V is merely an example and may change depending on the type and number of panels). After reaching 800 V, the voltage is continued to be raised and lowered around 800 V to maintain the apex using MPPT. Therefore, in connecting the MPPT-PCS to the optimizer, the MPPT-PCS can be made connectable if an output curve of the optimizer is controlled such that “on opposite sides of 800 V serving as an apex, the power will decrease with decreases in the voltage on a left slope and the power will decrease with increases in the voltage on the right slope.”

Using FIG. 6(a), details of the triangular control will be described more specifically as follows. FIG. 6(a) shows an example in which input power is set to 300 W and a target voltage is set to 800 V, where increases and decreases of the voltage and power are indicated by arrows “→” When the voltage of the power conditioner is lower than the target voltage of 800 V, if the power conditioner increases its voltage, the optimizer increases the electric power output and if the power conditioner decreases its voltage, the optimizer decreases the output power.

When the voltage of the power conditioner is higher than the target voltage of 800 V, if the power conditioner increases its voltage, the optimizer decreases the output power and if the power conditioner decreases its voltage, the optimizer increases the output power.

In this way, the optimizer induces the operating voltage of the power conditioner.

The triangular control can make the MPPT-PCS connectable by performing control such that the voltage-power curve (P-V curve) of optimizer output will become a triangular curve such as shown in FIG. 6(a). For example, “power control pulse width” of the optimizer may be kept unchanged as a “fixed value.” The use of a “fixed value” frees the optimizer from performing power control, and consequently the P-V curve of the optimizer output remains similar in shape to the P-V curve (FIG. 4(a)) of the panel (only boosting is done). Therefore, to obtain a P-V curve such as shown in FIG. 6(a), a pulse width (fixed value) that will result in an apex (MPP voltage) of 800 V can be selected.

The optimizer “continues to change the power control pulse width” so as to output maximum power at a voltage (e.g., 800 V) set by the power conditioner and the process of “continuing to change the power control pulse width” is OP-MPPT shown in FIG. 5(a). However, when the pulse width is set to a fixed value, the optimizer will become simply a “voltage converter that does only boosting by getting around panel output characteristics.” Therefore, in order to output maximum power, it is necessary that the MPPT-PCS should continue to change the voltage.

With the above-mentioned triangular control, OP-MPPT can be performed only at one point, namely at the apex (800 V), and thus, practically OP-MPPT cannot be performed sufficiently. This is because a power conditioner voltage at which one optimizer becomes 800 V does not cause another optimizer to become 800 V due to variation in detection voltage among optimizers, due to voltage losses of cables, and the like. That is, the triangular control cannot make the optimizers exhibit their strength of being able to “output maximum power of each panel.” This makes it necessary to provide a “range of constant voltage” used to perform OP-MPPT.

It is also conceivable to perform OP-MPPT in the flat region (voltage range in which the output power takes a constant value) of the plateau shape by controlling the P-V curve of the optimizer output such that the P-V curve will assume the plateau shape shown in FIG. 6(b). As a specific example, a range from 750 V to 820 V is used as a tracking range for OP-MPPT. Sloping portions of the P-V curve equal to or lower than 750 V and equal to or higher than 820 V are set by selecting fixed values of “power control pulse widths” appropriate to the respective portions. That is, a fixed value that will result in an MPPT voltage of 750 V is selected for the 750V-and-below portion and a fixed value that will result in an MPPT voltage of 820 V is selected for the 820V-and-above portion. Consequently, the P-V curve of the optimizer output becomes a P-V curve, “whose apex is 750 V or 820 V” and which is similar to the P-V curve shown in FIG. 4(a).

In the plateau shape control (without a boundary step) described in FIG. 6(b), around boundaries (around 750 V and 820 V in FIG. 6(b)) between “control in which the power control pulse width is fixed” and “MPPT control in which the power control pulse width is varied,” power differences are not clear because power changes are continuous. As a result, depending on control by the power conditioner, the voltage remains a little lower than 750 V or a little higher than 820 V, keeping OP-MPPT from being performed.

For example, if values of the optimizer output on the P-V curve are “295 W at 752 V and 290 W at 742 V,” the difference is only 5 W at 10 V (1.7%). If the voltage is 742 V, it is expected that the power conditioner will increase the voltage by 10 V such that 750 V will be exceeded, but actually a small power difference of about 5 W may be absorbed (ignored) due to variation in detection voltage (±8 V if the variation is ±1%), changes in quantity of light, and the like. This may result in a situation in which the power conditioner does not increase the voltage (decreases the voltage), and the voltage never reaches 750 V. Therefore, control should be performed such that “clear power differences” will appear around the boundaries.

For example, if values of the optimizer output on the P-V curve are “295 W at 752 V and 275 W at 742 V,” the difference is 20 W at 10 V (7%). If there is this clear power difference, when the power conditioner increases the voltage 10 V from 742 V, the increase in power can be recognized reliably, and thus the power conditioner increases the voltage to certainly above 750 V. That is, a transition to OP-MPPT will occur reliably.

### Embodiment

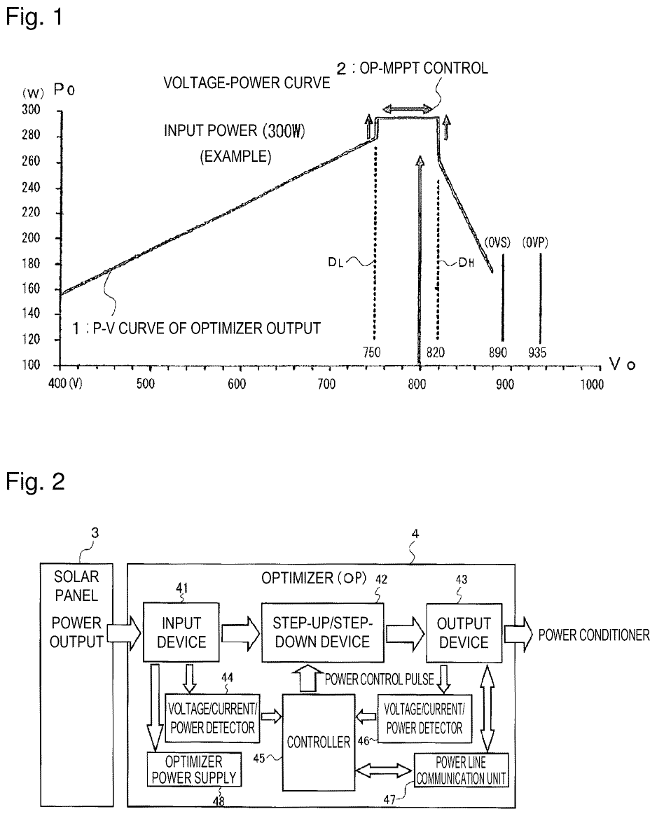

Based on the above description, an embodiment of the present invention will be described below using FIGS. 1, 2, and 3.

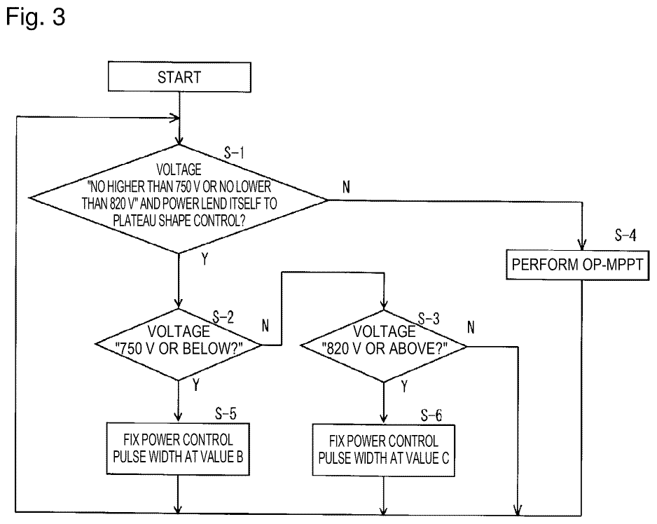

FIG. 1 is a voltage-power characteristic curve (P-V curve) illustrating an embodiment of an electric power control method and a voltage converter therefor in maximum power point tracking control according to the present invention, FIG. 2 is a functional block diagram of hardware used to perform OP-MPPT control shown in FIG. 1, and FIG. 3 is a flowchart illustrating a flow of control.

According to the present embodiment, a P-V curve of optimizer output is controlled so as to form a plateau shape having a boundary step (a clear power difference in a boundary region) shown in FIG. 1. For example, a step is provided at 750 V and 820 V. In the sloping portions equal to or lower than 750 V and equal to or higher than 820 V, fixed values of “power control pulse widths” that will make power values at 750 V and 820 V about 10% lower (voltage values that will make power differences practically clear) are selected. At 750 V or below, a fixed value that will make the MPPT voltage 800 V or above (e.g., 830 V) is selected, and at 820 V or above, a fixed value that will make the MPPT voltage 800 V or below (e.g., 770 V) is selected.

The 10 percent described above has been selected as voltage values that will make voltage differences actually clear.

That is, with reference to a voltage value of a maximum power point provided as an apex of a voltage-power curve (P-V curve), the operating voltage of the power conditioner is induced by keeping an optimum operating point, at which power of a solar panel 3 is maximized, at a constant power value forming a plateau shape (flat shape), which has a downside step, the lower end of which descends to slopes of the voltage-power curve 1 on a low-voltage side and a high-voltage side of the voltage-power curve.

Subsequently, the operating voltage of the power conditioner can be outputted by being kept in the constant fixed range in the flat sub-region of the plateau shape.

As an example, if a voltage at the maximum power point in the voltage-power curve is D_{T} (V), a voltage that matches the voltage-power curve on the low-voltage side of the plateau shape is D_{L} (V), and a voltage on the high-voltage side of the plateau shape is D_{H} (V); D_{L}<D_{H} and the power at the points of D_{L} (V) and D_{H} is lower than the power at the point of D_{T} (V) by ΔV (e.g., about 10% such as described above: clear power difference).

If the voltage at the maximum power point in the voltage-power curve is 800 V, which is a currently common set point, the voltage that descends until touching the voltage-power curve on the low-voltage side of the plateau shape is assumed to be 750 V and the voltage that descends until touching the voltage-power curve on the high-voltage side of the plateau shape is assumed to be 820 V.

In this way, with reference to the voltage value of the maximum power point provided as an apex of the voltage-power curve, stable MPPT control can be achieved by inducing the operating voltage of the power conditioner so as to fall within a constant fixed range in the flat sub-region of the plateau shape, in which a constant power value is maintained, where the plateau shape has a downside step, the lower end of which descends on a low-voltage side and a high-voltage side of the voltage-power curve.

FIG. 2 shows a functional block of hardware (optimizer) used to perform the MPPT control shown in FIG. 1. In FIG. 2, power output of the solar panel 3 is inputted to an input device 41 of the optimizer 4. The inputted voltage is adjusted to a predetermined voltage by a step-up/step-down device 42. Here, the inputted voltage is stepped up to 800 V and outputted to the power conditioner via an output device 43.

The input device 41 is connected with a voltage/current/power detector 44 for panel output and supplies control signals such as power control pulses to the step-up/step-down device 42 via a controller 45. Note that panel power inputted to the input device 41 is also supplied to an optimizer power supply 48.

The controller 45 has a function to keep power of the solar panel 3 to a constant power value with reference to the voltage value of the maximum power point provided as an apex of the voltage-power curve at which the voltage of the solar panel 3 is at a maximum such that the voltage-power curve will form a plateau shape having a step formed by straight lines falling down vertically on the low-voltage side and the high-voltage side, respectively, shown in FIG. 1 and abutting slopes of the voltage-power curve 1, induces the operating voltage of the power conditioner so as to fall within a constant fixed range in the flat sub-region of the plateau shape, subsequently keeps the operating voltage of the power conditioner in the constant fixed range, and outputs the operating voltage as generated output.

As described above, the step formed by straight lines falling down vertically on the low-voltage side and the high-voltage side, respectively, and abutting the slopes of the voltage-power curve 1 has a value that allows the power difference to be recognized clearly in power point tracking control and the D_{L} and the D_{H} have power values slightly lower than the power value of the plateau shape. Actually, the power difference is a design value established as a circuit ability (accuracy) during circuit design and is about a few percent to ten percent, but may be made larger depending on the voltage identification accuracy (ability) of the circuit.

The output device 43 is also connected with a voltage/current/power detector 46, and a feedback control signal for adjustment of boost power is generated by the output device 43 and is given to the step-up/step-down device 42 via the controller 45. If power line communication (PLC) is conducted between an external server or the like and the controller 45, a power line communication unit 47 is interposed.

FIG. 3 is a flowchart illustrating a flow of control performed by the controller 45. Each process step is expressed in S-xx format.

When control is started (START), the voltage/current/power detector 46 shown in FIG. 2 determines whether or not the voltage of the output device 43 is “no higher than 750 V or no lower than 820 V and whether the power lends itself to plateau shape control (S-1).

If the result of determination is “NO” (N: No), the controller 45 performs OP-MPPT to increase power by increasing or decreasing power control pulses (S-4) and returns to (S-1).

If it is determined in (S-1) that plateau shape control is possible (Y: Yes), it is determined whether or not the voltage value is “750 V or below” (S-2). If the result of determination is Yes, the controller 45 fixes the power control pulse width at value B (S-5) and returns to (S-1). Value B is a pulse width that has been estimated by the optimizer to cause maximum power to be outputted at 800 V and has been adjusted for use at a voltage “no higher than 750 V.”

If the result of determination in (S-2) is N, it is determined whether or not the voltage is 850 V or above (S-3). If the result of determination in (S-3) is N, the controller 45 returns directly to (S-1), but if the result is Y, the controller 45 fixes the power control pulse width at value C (S-6) and returns to (S-1). Value C is a pulse width that has been estimated by the optimizer to cause maximum power to be outputted at 800 V and has been adjusted for use at a voltage “no lower than 820 V.”

Through this procedure, the operating voltage of the power conditioner is induced in a range of “750 to 820 V” and subsequently kept in the range of “750 to 820 V,” thereby allowing OP-MPPT control to be performed.

The present embodiment allows optimizers to be connected regardless of the functions of commercially available power conditioners and allows maximum power output to be extracted on a panel-by-panel basis.

### REFERENCE SIGNS LIST

1: P-V curve of optimizer output
2: OP-MPPT control region (plateau shape)
21: intra-module parallel connection wire
3: solar panel
4: optimizer (OP)
41: input device
42: step-up/step-down device
43: output device
44: voltage/current/power detector (input side)
45: controller
46: voltage/current/power detector (output side)
47: power line communication unit
48: optimizer power supply
60: module
7: power conditioner (PCS)
8: system line

1. An electric power control method for maximum power point tracking control intended to efficiently extract generated output of a solar module made up of a large number of solar panels, wherein:
the solar module includes an optimizer adapted to boost power output of the solar module to a predetermined voltage, and power conditioner provided with an MPPT function; and
the optimizer induces an operating voltage of the power conditioner so as to adjust an MPPT target voltage of the power conditioner based on a voltage-power characteristic curve of the optimizer, and thereby obtains maximum output power of the solar module.

2. The electric power control method for maximum power point tracking control according to claim 1, wherein the operating voltage of the power conditioner is induced in manners described in Notes 1 and 2 below:
Notes
1. when voltage of the power conditioner is lower than a target value, if the power conditioner increases its voltage, the optimizer increases output power and if the power conditioner decreases its voltage, the optimizer decreases the output power.
2. when the voltage of the power conditioner is higher than the target value, if the power conditioner increases its voltage, the optimizer decreases the output power and if the power conditioner decreases its voltage, the optimizer increases the output power.

3. A voltage converter for maximum power point tracking control intended to efficiently extract generated output of a solar module made up of a large number of solar panels, wherein:
each of the solar panels includes an optimizer and a power conditioner provided with a maximum power point tracking circuit;
the maximum power point tracking circuit includes a controller configured to keep power of the solar panel to a constant power value with reference to a voltage value of a maximum power point provided as an apex of a voltage-power curve at which voltage of the solar panel is at a maximum, such that the voltage-power curve will form a plateau shape having a step formed by straight lines falling down vertically on a low-voltage side and a high-voltage side, respectively, and abutting slopes of the voltage-power curve; and
using the electric power control method according to claim 1, the controller induces an operating voltage of the power conditioner so as to fall within a constant fixed range in a flat sub-region of the plateau shape, subsequently keeps the operating voltage of the power conditioner in the constant fixed range, and outputs the operating voltage as generated output.

4. The voltage converter according to claim 3, wherein if a voltage at the maximum power point in the voltage-power curve is D_{T} (V), a voltage that matches the voltage-power curve on the low-voltage side of the plateau shape is D_{L} (V), and a voltage on the high-voltage side of the plateau shape is D_{H} (V); D_{L}<D_{H}, and values of power at a point of D_{L} (V) and power at a point of D_{H} are such that circuits making up the optimizer and the power conditioner can recognize power difference more clearly than a value of power at a point of D_{T} (V) in power point tracking control and that the D_{L} and the D_{H} are slightly lower in power than the plateau shape.
